(19) United States
(12) Patent Application Publication
(10) Pub. No.: US 2004/0148217 A1
(43) Pub. Date: Jul. 29, 2004

(54) Method and system for increasing accuracy in shipping and inventory forecasting

(76) Inventors: Stephen R. Lauring, Roseville, MN (US); Brenda J. Jensen, Plymouth, MN (US); Todd E. Curtis, St. Paul, MN (US); Eric A. Taylor, Eden Prairie, MN (US)

Correspondence Address: GENERAL MILLS, INC., P.O. BOX 1113, MINNEAPOLIS, MN, 55440, US

(21) Appl. No.: 10/350,983

(22) Filed: Jan. 24, 2003

(51) Int. Cl. G06F 17/60

(52) U.S. Cl. 705/10

(57) ABSTRACT

The present invention is directed to a method and system to improve the accuracy of shipment forecasting in order to control inventory build and depletion periods. Precision in shipment forecasting stabilizes management of retail products or brands and the related or associated portfolio and connected business units. The process of the present invention involves the establishment of an initial data foundation that is created through the use of retail sales forecasts obtained from various consumer data sets. The system then applies one or more additional data sets that include information pertaining to historical shipments (actual sales) and inventory information to the first or foundation data set. These data sets are then reconciled with one another to obtain shipment forecast and inventory control levels. These commingled data sets provide a data pattern or map that is then used in conjunction with the retail sales forecast to assist in estimating future shipments for inventory demand or decline. The resulting information set provides a better or more accurate forecast of expected shipment volumes and projects inventory build or depletion periods thereby providing an improved forecasting tool to more accurately predict the retail environment's inventory position, thus facilitating better brand management.

### CROSS-REFERENCES TO RELATED APPLICATIONS

Not applicable.

### FIELD OF THE INVENTION

The present invention is directed to a method and system to improve the accuracy of shipment forecasting in order to control inventory levels. Precision in shipment forecasting stabilizes management of the manufacturing, distribution and the general logistics associated with retail products or brands and the related or associated portfolio and connected business units. The method and system of the present invention involves the establishment of an initial data foundation that is created through the use of retail sales forecasts obtained from various consumer data sets. The system then applies one or more additional data sets that include information pertaining to historical shipments (actual sales) and inventory information to the first or foundation data set. These data sets are then reconciled with one another to obtain shipment forecast and inventory control levels. The commingled data sets are then used to provide a data pattern or map that is then used in conjunction with the retail sales forecast to assist in estimating future shipments for inventory demand or decline. The resulting information set provides a better or more accurate forecast of expected shipment volumes and projects inventory build or depletion periods thereby providing an improved forecasting tool to more accurately predict the retail environment's inventory position, thus facilitating better brand management.

### BACKGROUND OF THE INVENTION

Traditionally, many companies have used historical sales information to predict volume requirements for the coming years. This information can take many forms and it typically includes straightforward listings of categories and the prior sales that occurred in those categories, segments or areas. Unfortunately, such forecasting is rearwardly looking in nature and regrettably can produce a relatively high margin of error when trying to predict future shipments. This regrettable result can be due to any number of situations, events or conditions that are not accounted for. The result can be particularly damaging when the forecast numbers for future or predicted sales make up a large portion of one's business, as a double-digit margin of error in a forecast quickly translates into significant losses.

In generating typical forecast modules, companies will usually take averages of sales that have occurred over a predefined period such as several previous months, calendar quarters or years to generate the possible sales volume forecasts for the coming equivalent period. As indicated above, this information can often be inaccurate and can lead to the manufacturer missing production demands during inventory build periods, loss of customers due to delivery shortfalls, and over or under stock problems and other scheduling and inventory difficulties.

It was, and still currently is thought that by using data obtained over a pre-defined period of time and simply averaging that sales information without considering other factors that may have affected sales in prior years, a relatively stable forecast can be determined for the coming equivalent period of sales for which the forecast has been requested. However, such a simple application of data and the relatively straightforward interpretation of that information does not take into consideration any number of variables that might affect or create a skew in sales in any particular month, calendar quarter, year or other sales period. These variables can generate significant inaccuracies in forward-looking forecasts. For example, where the forward looking forecasted volume is too high, the manufacturer will likely have to take product back from the retailer's inventory or product will go stale in the inventory, necessitating it's disposal. Alternatively, where the product has a longer shelf life, the retailer may not take any additional delivery of product until inventory levels are acceptable causing a fall off in manufacturing, leading to possible employee layoffs. Where the forecasted volume is too low, the manufacturer is caught without sufficient product to meet the need of the marketplace, which causes loss of sales and of course profits. In each instance, the relationship with the retailer likely becomes strained.

In an effort to remedy the discrepancies in forecasts, some companies have attempted to modify the historical data through the use of supplemental factors. This supplemental information may include demographic information, economic indicators such as inflation, or category trends. However, even with this supplementation, the trended sales data still suffers from a number of inaccuracies due to other factors that are not considered in such applications and the differences between actual shipments and predictions or forecasts can still deviate by 10 to 25% or more.

Where shorter term forecasting is used, such as trying to predict product demand for the next 30, 60 or 90 days, deviation between forecasted amounts and actual shipments can be even further skewed and be off from actual requirements by as much as 40% or more. This can be particularly difficult in areas where products are not “shelf stable” such as perishable goods or items (refrigerated dough, bakery goods and the like) or where the “shelf stable” period of the product runs only the length of the forecasted period. That is, a product may be shelf stable for only 8 weeks, and a 60 day forward looking forecast would not be able to adjust for demand turns, up or down, in product sales before the product life would expire leading to either spoilage or unfilled consumer demand.

In addition to the foregoing problems, current forecasting methods can also vary widely even within one company, as different departments may utilize different methodologies leading to no consistent or standardized approach. This is likely due to the high margin of error associated with forecasting and the desire to try new processes to increase the accuracy of forecasting and avoid discrepancies. Such disparities in forecasting methods within companies may even occur within single business units and across differing product lines or even brands within a portfolio. This understandably makes it difficult for management to understand how business units arrived at particular objectives or economic targets further compounding the forecasting problem. Due to such variability in forecasting, there is little confidence when “numbers” are generated in connection with such forecasts making planning and financial outlooks difficult to reconcile.

There is also the tendency to manipulate forecasts such that the forecasts meet or are in line with unit or area business expectations for the coming fiscal year. Such “forcing” of forecasting leads to further deviation in actual sales versus potential shipments. This situation creates further disruptions between the manufacturer and the retailer or wholesaler and contributes to the discontent between management and the business units.

Thus, what is needed is a method and system through which the accuracy of forecasting can be improved and utilized across divisional and brand boundaries with relative ease of application. More accurate forecasting delivers many benefits to the manufacturer including more efficient procurement of raw materials, use of labor force, distribution of product resulting in lower holding costs, and fewer write-offs of wasted product. More efficient forecasting also provides a better framework for making adjustments to future advertising, promotion, merchandising and pricing plans.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to the creation of objective and realistic future volume estimates or forecasts by tracking the result or impact of each of a number of individual elements, factors, drivers or inputs that are provided or loaded into a base model database. This model is then reconciled with other data sets to generate a more concise and accurate picture of future volume requirements and inventory levels. Through monitoring of each of the respective inputs or drivers, and adjusting the model, the amount of deviation between the actual shipments (historical) and those forecasted shipments (future) can be significantly reduced if not mostly eliminated.

The present invention takes the forecast that is obtained from the historical data (actual retail sales) and interprets and adjusts this information in view of selected other data sets in addition to ancillary or external elements that typically have an impact on consumer demand for products but are often overlooked or not considered. The additional data sets include inventory information as well as shipment arrangements across a number of areas. Some of the ancillary or auxiliary elements or factors include, but are not limited to, competitive offerings, new products, changes in marketing focus, and changes in inventory levels, advertising, merchandising and promotions, pricing and packaging and the like. Any number of combinations of these additional elements is then used to modify the forecasted data to provide a better indication of when to expect decreases or increases in demand for the products provided by the company. In addition, external factors can be considered such as weather, labor disruption, natural disasters and the like.

Enabling more accurate forecasting also permits manufacturers to obtain raw materials during times where demand might not be as great. For example, winter typically brings on an increase in baking as more consumers are at home. The ability to purchase raw materials for baking products during the late summer when demand is low provides significant cost savings. In addition, accurate forecasting reduces inventory shortfall in providing retailers with inventory in advance of when the demand is expected. Moreover, such accurate predications can also allow manufacturers to scale back inventory stocking or building efforts as seasonal or other downturns are more readily anticipated. The creation of more accurate forecasting information precludes the retailer or wholesaler from having to dispose of product and reduces the strain on the relationship with the manufacturer.

Forecasting accurately also permits the more beneficial use of shipping assets and allows a manufacturer time to reposition its own transportation requirements and contract for additional volume in advance of critical operation. Perhaps most importantly, accurate forecasting also allows for a more effective use of labor in connection with production and delivery requirements. Overtime labor or additional expensive shift labor can be avoided if production schedules can be spread more evenly to provide product in advance of inventory build times as opposed to having to manage the crush of production requirements during times of high demand.

In one embodiment of the present invention a method for increasing forecasting accuracy for shipment and inventory control, is described and comprises the steps of initially providing a consumer demand forecast module having at least a first data set that includes at least consumer purchase levels. A group of supplemental factors known to influence consumer sales is provided. The consumer demand forecast model is then utilized to formulate a sales forecast or projection. The sales estimate is adjusted by introducing at least a portion of a first group of supplemental factors to the estimate or forecast. Next, a historical inventory data set is generated from the actual historical shipments. The sales estimate is merged with the historical inventory data set and then these data sets are aligned and used to create an estimate of future shipments for at least one location or commercial segement.

In a further embodiment of the present invention a system for increasing forecasting accuracy for shipment and inventory levels is described and comprises a first data set that includes at least a consumer demand profile. The consumer demand profile is obtained from historical purchasing levels that have been adjusted according to at least a portion of a group of ancillary elements. A second data set is provided and includes historical shipment information that has been adjusted according to at least a portion of the group of ancillary elements. A third data set is provided and includes historical inventory levels from at least one location. A calculator is included and compares information contained in each of the first, second and third data sets to generate a correction factor to modify the consumer demand profile contained in the first data set. The system produces a forecast that illustrates future shipment and inventory requirements for the at least one location.

In a still further embodiment, the present invention describes an additional method for determining inventory build and bleed times for consumer products, and includes the steps of initially providing a first data set collected from a grouping of historical purchasing trends. The first data set is then modified with at least a portion of a consumer expectation data set that has been created from a compilation of information obtained from a pre-selected group of supplemental factors that effect volume requirements. A second data set is then provided and has inventory information supplied from at least one ship to location. A third data set is created and includes historical shipping information obtained from shipment data to the at least one ship to location. The first, second and third data sets are then merged together to modify the consumer expectation data set. The consumer expectation data set is reported and then sent to at least one scheduling facility such that the scheduling facility can accurately predict shipping demands for future shipping periods based on retailer requirements.

In a yet still further embodiment of the present invention a shipping demand forecasting system is described and includes a first data set including information on actual sales information, the first data set further including data from a group of supplemental factors that effect such sales information. A second data set including information on inventory levels for at least one location and a third data set including information on actual shipments made to the location. A comparator is used for comparing the first data set to the third data set to create a correction factor that is used to generate a sales information forecast. Once this information is obtained, the comparator then compares the sales information forecast with the inventory levels from the at least one location. From the information, the comparator then creates a report setting forth an estimated shipping forecast for the at least one location from the first, second and third data sets and the report provides information for planning for the group of supplemental factors.

There are a number of permutations possible for each of the foregoing embodiments and one with skill in the art would readily recognize such variations.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a high level flow diagram of the present invention illustrating the steps in creating the forecast;

FIG. 1A shows an exemplary retail sales, inventory and shipment calculation worksheet;

FIG. 1B shows an exemplary graph plotting inventory over an entire category;

FIG. 2 shows an exemplary block diagram of an exemplary illustrative system;

FIG. 3 provides a flow diagram illustrating the calculation/analysis performed by the present invention;

FIG. 3A provides a continuation of the flow diagram illustrating the calculation/analysis performed by the present invention; and

FIG. 4 illustrates the shipping forecast module of the present invention.

### DETAILED DESCRIPTION OF THE INVENTION

The present invention is now illustrated in greater detail by way of the following detailed description, but it should be understood that the present invention is not to be construed as being limited thereto.

When this novel process is used for single brands, multiple brands or the entire portfolio of brands, business units can better manage their efforts to maximize sales and profit. The accumulation of all these benefits allows the manufacturer to have a better perspective on their future financial position and fiscal resources.

The system and method of the present invention uses a sophisticated, multiple part, integrated, forecasting technique to arrive at a new or future monthly estimate of retail takeaway (amount of product volume that is sold at retail, wholesale and channel outlets), inventory levels as well as future shipment forecasts. These forecasts can be applied over the entire trade (e.g. grocery stores), or to limited segments such as to a single significant retailer, alternate channel retailers (e.g. drug stores, convenience stores, discounters) or combinations thereof. In addition, the system and method of the present invention can be used for single brands, multiple brands, unrelated brands and across entire portfolios.

The present invention overcomes the issue of inaccurate forecasting by calculating multiple periods of retail sales and then correlating that data to the actual shipment data and inventory data to provide a more accurate representation of the actual sales information that has occurred. This factor is then applied to the forecast amounts to adjust the anticipated shipment and resulting inventory levels either up or down. In order to calculate the monthly anticipated inventory amounts, the following formula is applied:

BEGINNING INVENTORY+SHIPMENTS−RETAIL SALES=ENDING INVENTORY

ENDING INVENTORY/SUPPLEMENTAL FACTORS=FUTURE REQUIREMENTS

The above calculations are conducted for each of the historical periods for which the data is sought for inclusion in the system and for subsequent adjustment. In considering future forecasting situations, the forecasted retail sales are input into the data set. If the data solely calculated the retail sales, eventually, the data would show a negative inventory position (inventory being depleted without the inventory being supplemented through new shipments). Instead, a monthly shipment forecast is commingled with and entered for each future month that a retail forecast is sought, thus preventing a negative inventory position.

The system and method of the present invention uses an initial foundation that is obtained from the historical data, or actual sales data or “takeaways” at the retail environment. That first data set also includes the introduction of a number of ancillary or supplemental factors or drivers, which can be overlaid with various other economic indicators or conditions effecting the sales volume. The historical data set or foundation (recorded or actual sales) is compiled through the use of interpreting information that includes other supplemental elements that typically have an impact in consumer demand for products but are often overlooked or not considered. Some of these elements include, but are not limited to the increase/decrease in the number of competitive offerings in the same SKU, the introduction of new products, changes in marketing focus surrounding competitive offerings, changes in retailer/wholesaler relationships, acquisitions and divestitures of companies as well as transportation and manufacturing assets, changes in management and other accounting requirements and the like. Each of these additional elements or factors is then used in the creation of the historical data (actual sales) to create a forecasted data set that provides manufactures with a better indication of when and why the sales took place and potentially when to expect increases in demand for products that the company provides for coming periods. In addition, external factors can be examined to determine what sort of impact, if any, that such factors may have had on the forecasting information. Such external factors include, but are not limited to labor unrest, weather, natural disaster and the like.

A significant factor in addressing inaccuracies in prior forecasting methodologies is in identifying and then calculating lost or missing sales in order to make an adjustment to the historical information. That is, not all sales that occur in the retail environment are actually captured by the retail scanner at the check out. For example, where a consumer buys five different varieties of a meal kit, but all have the same price, the cashier may scan the first item and then have the register calculate the four additional sales from the single item, rather than scan all five boxes. This sale is recorded as a sale of five of one type or specific offering of a meal kit as opposed to single sales of five different varieties. Thus, recordal of sales in this fashion can on a cumulative basis provide inaccurate data as to the type and amount of product actually removed from the shelves at the retail location. Retail scanners can also miss the bar code, which allows the sale to go unrecorded. That is, the retail employee passes the article over the scanner but the sale si not recorded. Alternatively, the wrong code is entered into the scanner and as such sales of a different products are then recorded. These examples represent only a small portion of the possible errors that can lead to inaccurate forecasts at the retail scanner or checkout.

However, there can also be a more significant factor in determining the actual sales made at a location or for a particular significant retailer. That is, a “ship to” location or retail location may order a certain amount of inventory for delivery to a particular location such as to a warehouse or distribution facility for a retail group. The retailer or location may order an amount in excess of its normal requirements of product, in order to receive favorable pricing from a manufacture by purchasing in a higher volume and then reship or divert part of that inventory to another location, retailer or channel. That is, a retailer in order to get volume discount pricing, places an order in bulk. The retailer then keeps that portion of the shipment that the retailer actually needs to meet its anticipated requirements and then sells off the remaining inventory to another retailer. Failure to account for, or notice this activity would ultimately end up creating a sizable skew in future shipment forecasting models to that location, as a straight forward shipment forecast module would assume a similar amount of product would need to be shipped to such location in future or similar periods. However, when the actual order comes in from that previous ship to location or retailer, the requested shipment is significantly different from the forecasted shipment amount due to the diversions that were unrecorded by the manufacturer. This causes disturbances in the forecasts, such variations may be significant and likely cannot be made up during the remaining fiscal year.

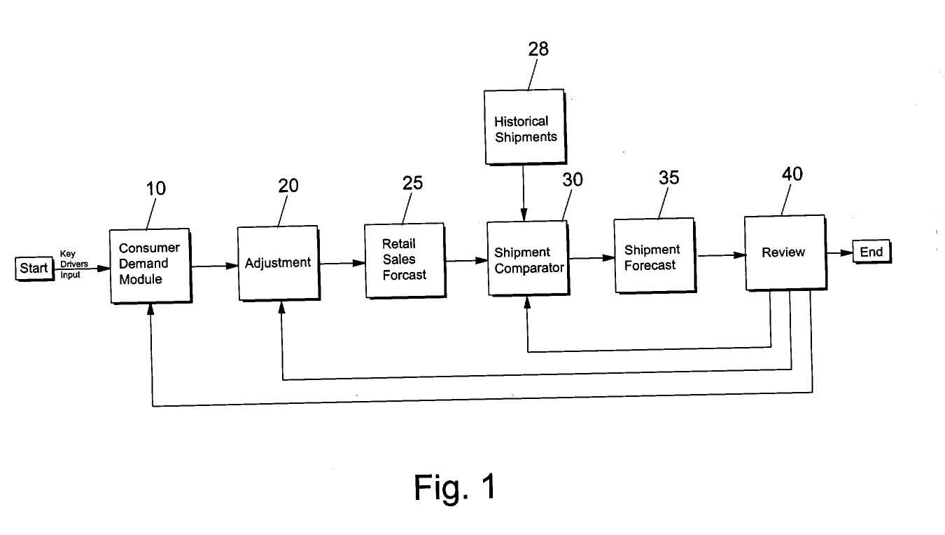

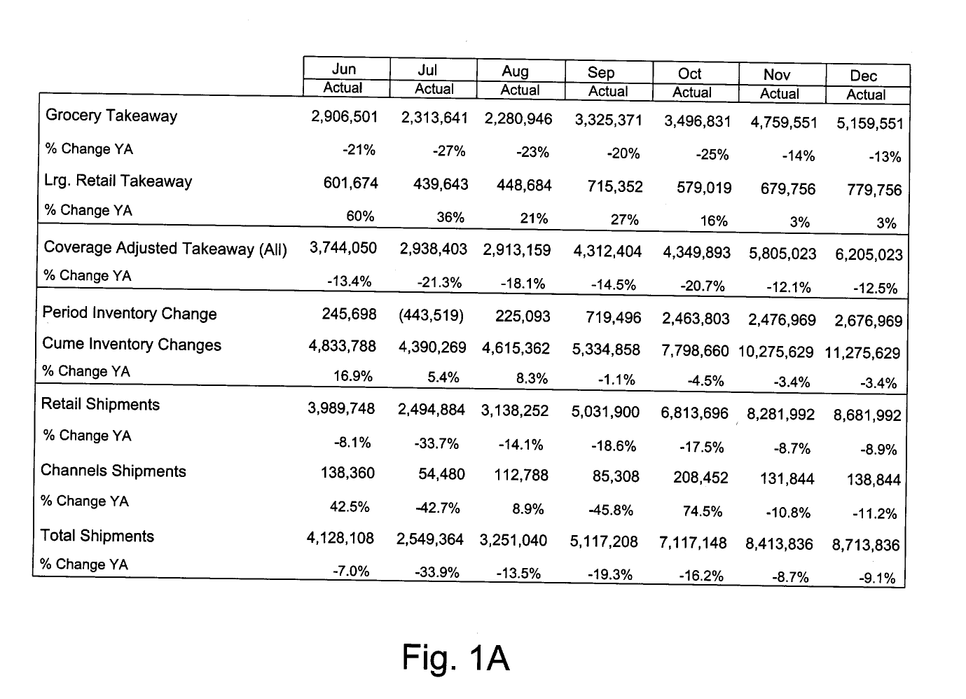

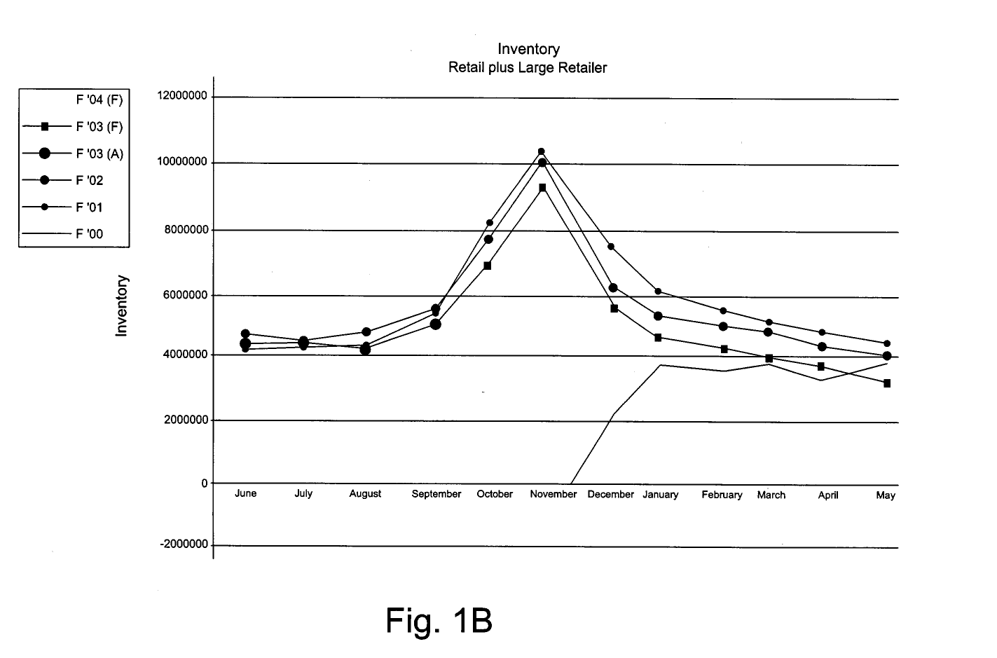

Turning to FIG. 1 the method of the present invention is illustrated through a high level flow diagram and includes a consumer demand module or model 10, which contains some fundamental information, such as what products are anticipated to be sold at the retail level. The model 10, which is also referenced herein as the first data set is also provided with preliminary foundation data that is created though the use of historical data elements such as the number of units sold at the location to which shipments were previously made and inventory levels.

The model 10 is a consumer demand oriented module that in addition to containing foundation information described above, also includes input from various marketing plans or drivers that are used to calculate anticipated product or brand “takeaway” (that amount of product actually sold at retail stores). The model 10 may also include a number of supplemental inputs, elements, or other drivers that relate to various factors that have an impact on sales of products, such as the number of competitive products in the market place, the existence of a promotional tie in, current level of product innovation, advertising campaigns and the type of such campaigns, merchandising, packaging sizes, pricing levels, time of year (seasonal) and the like. Typically, the number of drivers or inputs range from four to twelve, but more or less can be used depending on the modeling desired. Once the model or data set 10 is created, it can be used for other simulations through use of different or additional factors or drivers.

The model or first data 10 is used as a starting point in order to estimate what might be sold at the retail level on the basis of pre-selected “response functions.” These response functions may be derived from historical performance of the portfolio, brand or product line. The output of the first data set or module 10 is a fact based consumer demand forecast that can be further adjusted at adjustment module 20. The further manipulation or adjustment at model 20 occurs through the use of additional drivers, elements, factors or inputs relating to seasonality or momentum that a product may carry, such as after a recent media blitz or tie in with another event, like a recently released theatrical film or sporting event or character.

Other modifications to the data emanating from module 10 may be made due to previously undeveloped factors such as loss of manufacturing capacity, increase in shipping expenses, unavailability of ingredients, etc. or through other groups of items such as advertising, merchandising, pricing, sizing, etc as well as external or factors beyond control such as severe weather, labor disputes, increase in competitive activity, disruption/dissolution of corporations. The adjustment module 20 then recalibrates the results obtained from the original product model or first data set 10 to further refine the input based on additional drivers or other factors. The final output is the retail sales forecast depicted by reference to numeral 25.

In the present example, the data from the retail sales forecast 25, is then commingled with historical inventory information contained in the comparator represented by reference numeral 30 (the actual shipments received by retailers/wholesalers/channels and resident or retained at the location). The historical inventory level is created from information provided from a further data set 28 depicted as historical shipments (sales or deliveries made to retailers/wholesalers). The historical inventory data set 28 is derived by aligning historical monthly shipments to actual historical monthly retail sales.

The historical shipment information 28 is determined by evaluating a number of factors. The first step is to initially look at the previous month as well as previous months in prior years. For example, if the current shipment month is October 2002, one would look at September 2002 as well as October 2001 and possibly October 2000. A rough estimate would be to ship an amount of product that is generally equivalent to the prior month (excluding seasonal spikes which can be accounted for by looking at prior years). However, this has lead to inaccuracies in forecasting volumes and hence the need for further refinement of the calculation.

The historical shipment information 28 is then compared with the retails sales forecast information provided by module 25 at the comparator module 30. The shipment comparator module 30 then analyzes the information and makes any adjustments that are necessary due to various supplemental factors and uncovering inventory divert situations. The comparator module 30 conducts an evaluation that includes the existing level of inventory currently carried by the retail or wholesale outlet or location. This information has been provided by the retail sales forecast information 25. If the inventory level too high, then the shipment forecast amount should be reduced, implementing an inventory “bleed” period (reduction in inventory). Alternatively, if the inventory too low or “light” this will require an inventory “build” (increasing inventory levels) to meet anticipated consumer demand. An example of an inventory build period may include seasonal requirements, such as holidays.

Once the inventory information is collected, the inventory information is formatted so that an adjusted retails sales forecast can be viewed as a shipment forecast. The format will illustrate the “actual” shipments that represent previous months or historical months as well as future months that are shown as forecasted amounts. The inventory amounts are depicted in either a term or period (referring to a period of time such as a month, calendar quarter, six months, year, etc.) as well as on a cumulative basis (six month cycle, year, duration of the relationship with the retailer or wholesaler, etc.). The shipment comparator module 30 then generates an anticipated shipment forecast designated by reference number 35.

The resulting shipment forecast 35 is a better forecast of expected shipments and hence creates information that leads to improvement in manufacturing accuracies. With an improved forecast and more complete understanding of the trade's or retailer's inventory position, better business decisions can be made for the brand. When the process is used for multiple brands, the entire portfolio of brands can be better managed to maximize sales and profit.

Once the shipment forecast 35 has been generated, the system then initiates a review step 40 to permit an initial look at the data that has been collected and subsequently manipulated. During the review 40, additional drivers or factors can be identified for use in creating future base model 10 or alternatively, drivers or factors used in the previous model 10 can be eliminated. The review 40 can also require additional adjustments be made at step 20 in view of other data collected from third party data sets, such as A. C. Nielsen, or from internally derived information. The review step 40 may also trigger that the shipment forecast 35 be adjusted at shipment comparator 30 based on any of the criteria received as part of the data set.

In configuring the output or calculations of the present invention, the initial data set 10 produced by the present invention includes as a starting point the number of units of products sold (historical, actual sales). The historical retail sales units by month are tracked and calculated and stored as a first data set and displayed for inspection using a suitable format such as a chart, spreadsheet or the like. Future month information is also displayed. The future months forecast is made up of results from retail forecasts 25 and shipment forecasts 35. A second data set, provides the number of units sold each month (actual shipments to the retail outlets as opposed to actual products purchased by consumers) are applied to the first data set. Occasionally, such as quarterly or annually an alignment factor (e.g. seasonal, promotion and advertising, etc.) is applied to the two different sets of information so that the two or more data sets are brought into better correlation by the correcting or adjustment element. An exemplary calculation worksheet showing sales data (“takeaway”), inventory level and shipment is provided in as FIG. 1A.

FIG. 1B illustrates a graph that plots inventory level over an entire category or segment. Here the graph is plotted for grocery and includes large retailer volume. The chart provides details with respect to historical or actual shipments/sales and inventory along with current forecasted information.

The displayed data provides insight not only for use in predicting shipments and inventory levels, but the information is also used in production planning, allocation of manufacturing resources and in providing an additional data set that is usable for financial expectations and performance of the affected brand or portfolio.

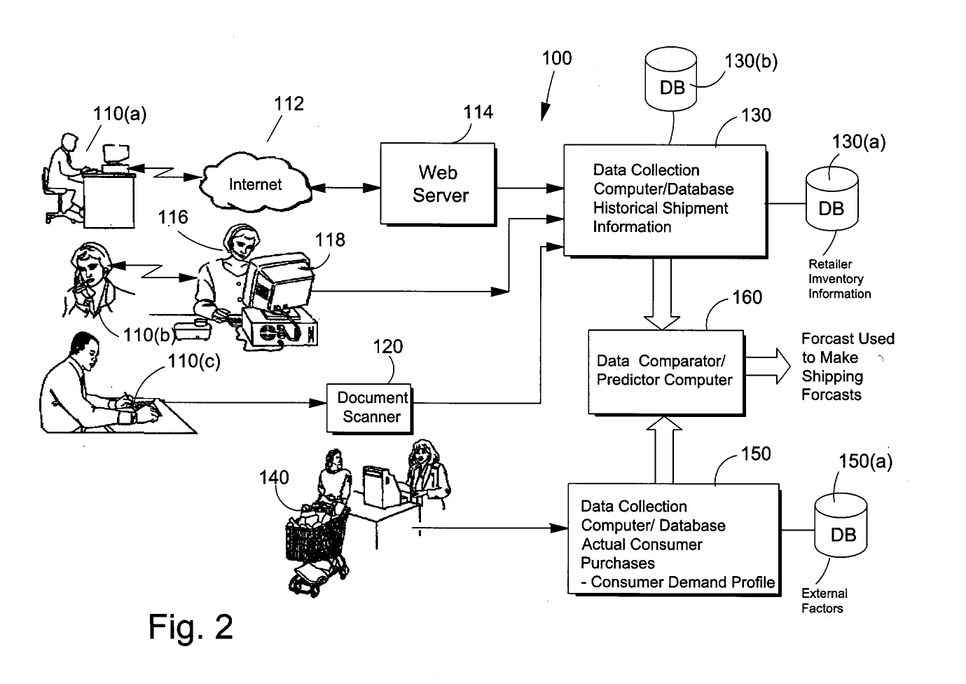

Referring now to FIG. 2, the data is collected through an exemplary system 100 that includes various data collection mechanisms 110 (e.g. networked personal computers 110(a) and other Internet appliances, telephone 110(b), data entry forms 110(c), as examples) that are used to collect information relating to forecasting and shipments. These mechanisms 110 may use any number of transmission paths (e.g., the Internet 112 and associated web server 114 in the case of a web appliance 110(a), telephone operator 116 entering data in a data terminal 118 in the case where shipment information is “phoned” in, and a document scanner 120 in the case of filled in forms 110(c) to collect data and provide it to a data collection computer/database 130. The data set 130 can be further modified by external factors 130(a) and 130(b). These mechanisms shown in FIG. 2 are not exhaustive—other conventional ways of gathering data concerning shipments, sales volume and forecasting and associated behaviors are known and any such techniques may be used.

The preferred illustrative embodiment uses conventional arrangements 140 such as grocery or other store scanners, inventory control systems, other surveys, etc. to collect data measuring purchasing levels for use in the foundation of the model 10. This data is collected and stored in a data collection computer database 150. The data may be broken down by various criteria such as demographics, seasonal purchasing, geography and other characteristics as is well known to those skilled in the art, and modified or adjusted through external drives 150(a). The data obtained in data sets 130 and 150 are then reconciled and compared at module 160 through use of a calculating arrangement to produce a shipment forecast.

In the exemplary illustrative embodiment, the data comparator/predictor computer 160 compares the actual consumer purchasing data 150 for the products with the actual or historical data compiled by the data collection computer/database 130 (see FIG. 2). The data comparator/predictor computer 160 uses the result of the comparison to generate a forecast indicating the future shipment amounts.

Through the use of the system, a number of scenarios can be generated and reviewed as necessary at module 40 (FIG. 1). These may include hypothetical effects of pricing increases or decreases, advertising for the product, product distribution, package sizing, line extensions and the like.

The ability to identify stable or growing distribution also identifies opportunities to possibly enhance shipments or inventory build periods. Growing product distribution areas also identifies areas that are likely suitable for product line extensions within that product offering. For example, a meal kit that is doing relatively well and is experiencing heightened demand, may be the subject of a line extension, such as adding a new flavor to the product offering. Likewise, the identification of declining distribution can also signal the opportunity to scale back varieties or line extensions so as to minimize or reduce erosion of product share.

Through the use of the present invention, the deviation between historical forecasting errors and the actual demand based forecasting system described herein has a margin of error comprising a single digit, i.e. plus or minus 5% compared with traditional models of 20% or more.

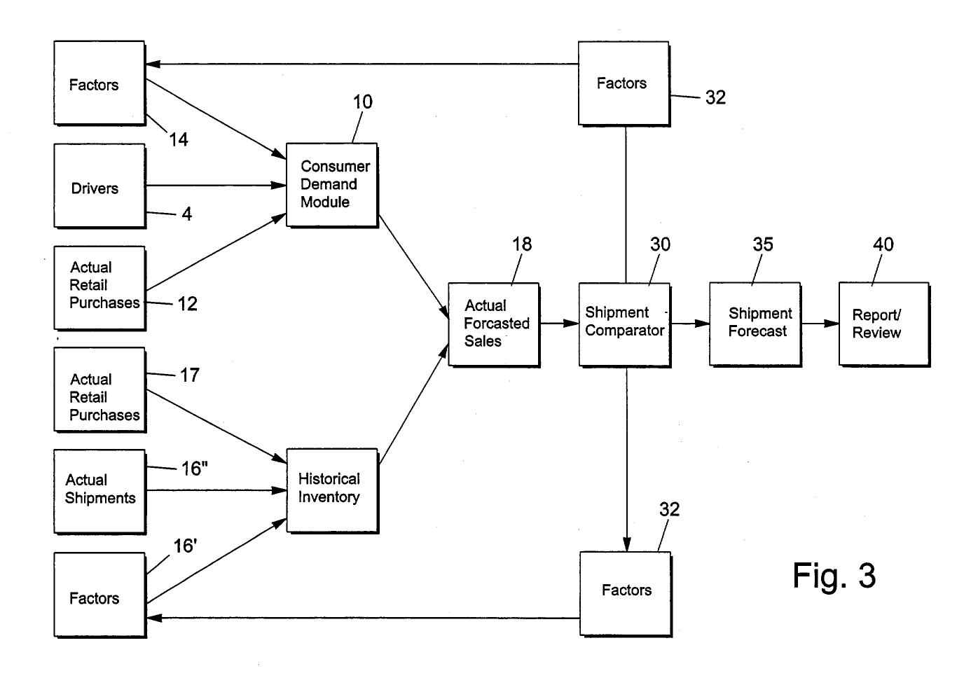

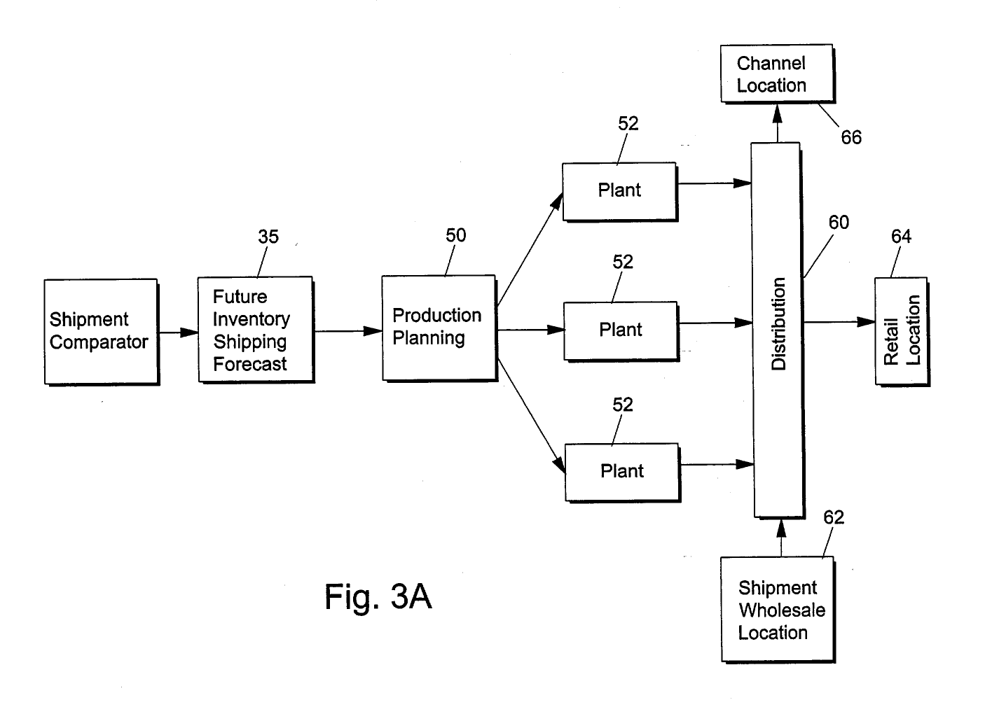

FIG. 3 provides a more detailed flow diagram for the present invention that is depicted in FIG. 1. The consumer demand module 10 is created through the inclusion of actual retail purchase data 12 and supplemental factors 14, as well as drivers 11 referenced above. The actual retail purchases 12 are those that are recorded at the ship to location, retail outlet or outlets. The supplemental factors 14 include such things as pricing, advertising levels, merchandising, packaging size, seasonality, and combinations thereof. In addition other external factors may be included in this configuration such as natural disasters, dramatic swings in competitive activity, corporate or labor disruptions.

Once the building of the consumer demand module 10 has been completed the information is merged or integrated with historical inventory information 16. The historical inventory information 16 is created through the combination of factors 16′, actual shipment information 16″ and actual retail sales information 17. These combined data sets (16′, 16″ and 17) that form the historical inventory module 16 along with the consumer demand module 10 generate an actual forecasted sales data set 18 which then aids in providing information for creating a future inventory shipment forecast 35 (also as shown in FIG. 1). The forecast 35 is created through the use of the shipment comparator 30.

The shipping comparator 30 can aid in the identification of external factors 32 that are used in further refining consumer demand module 10. These new or revised factors are stored in data set 14. In addition, the supplemental factors 32 can also be used in adjusting the supplemental factors 16′ that are used in adjusting the historical inventory module 16.

The shipment comparator module 30 also is responsible for generating various reports and reviews 40 that can be used by the various business teams, planners and the like to understand the arrived upon forecast information.

FIG. 3A illustrates the continuing flow of the method from FIG. 3. Once the inventory shipment forecast 30 has been provided by the system of the present invention, the information is used for production planning 50. Operations provide information and instructions to one or more plants or manufacturing facilities 52 in order to provide for product production and planning. Once the manufacturing schedule is completed at the plant level 52, the plants arrange for distribution 60 to one or more locations. These locations can include wholesale locations 62, retail locations 64, and channel locations 66. Other locations, that are not shown in the drawings may include warehouse locations, shipping terminals and the like.

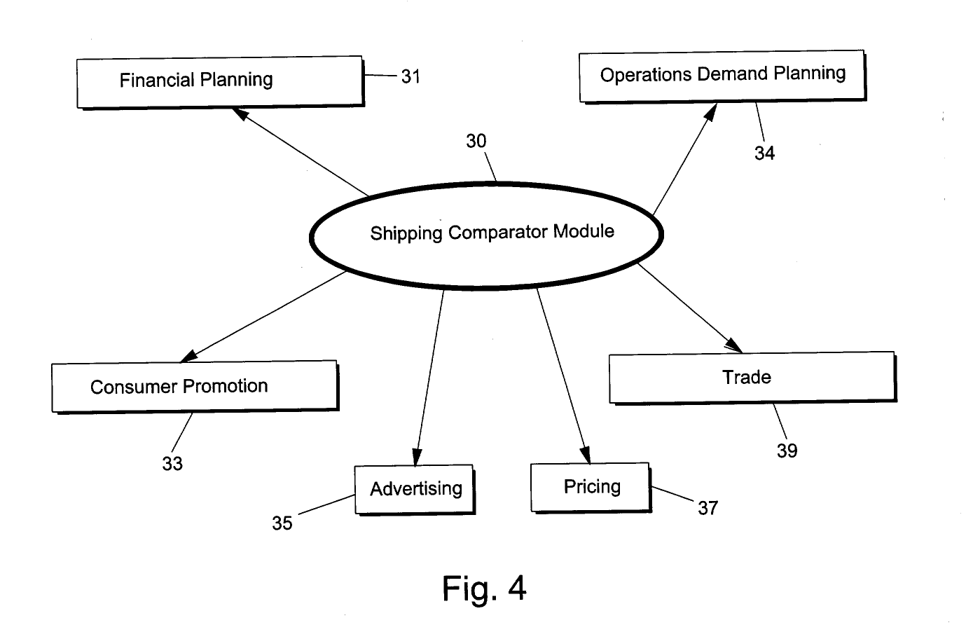

FIG. 4 shows a flow diagram that provides for the shipping forecast module 30 and the potential distribution of the information created in that module to any number of output locations. These include financial planning 31; consumer promotion 33, advertising 35, pricing 37, trade 39 and operations demand planning 34. Many of these outlets are used in formulating the external factors 32, 16′ and 14 that are used to adjust the various modules of the present invention.

It will thus be seen according to the present invention a highly advantageous system and method for increasing inventory build and shipment-forecasting accuracy has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A method for increasing forecasting accuracy for shipment and inventory control, comprising the steps of:
providing a consumer demand module for products having at least a first data set including consumer purchase levels;
creating a group of supplemental factors known to influence said consumer purchase levels;
utilizing said consumer demand module to create a sales forecast;
introducing at least a portion of said supplemental factors from said first group of supplemental factors to said consumer demand module;
adjusting said sales forecast based on said supplemental factors;
providing historical shipment information in a second data set;
creating a shipping forecast by integrating said second data set with at least a portion of said first group of supplemental factors; and
aligning said shipping forecast, and said sales forecast to create a future inventory shipping forecast to accurately estimate future shipments and inventory requirements for at least one commercial segment.

2. A method for increasing forecasting accuracy for shipment and inventory control as recited in claim 1, wherein said products are consumer goods.

3. A method for increasing forecasting accuracy for shipment and inventory control as recited in claim 2, wherein said consumer goods are intended for human or animal consumption.

4. A method for increasing forecasting accuracy for shipment and inventory control as recited in claim 1, wherein said first group of supplemental factors includes pricing, advertising levels, merchandising, packaging size, seasonality, and combinations thereof.

5. A method for increasing forecasting accuracy for shipment and inventory control as recited in claim 1, wherein said at least one commercial segment includes retail and wholesale locations.

6. A method for increasing forecasting accuracy for shipment and inventory control as recited in claim 5, wherein said retail and wholesale locations are grocery outlets.

7. A method for increasing forecasting accuracy for shipment and inventory control as recited in claim 5, wherein said retail and wholesale locations include channel outlets.

8. A method for determining inventory build and bleed times for consumer products, comprising the steps of;
initially providing a first data set collected from a grouping of historical purchasing trends;
modifying said first data set with a portion of a consumer expectation data set; said consumer expectation data set containing information obtained from a pre-selected group of supplemental factors that effect volume requirements;
providing a second data set having inventory information from at least one location;
creating a third data set having historical shipping information obtained from shipment data to said at least one location;
merging said first, second and third data sets to modify said consumer expectation data set; and
reporting said consumer expectation data set to at least one scheduling facility such that said scheduling facility can accurately predict shipping demands.

9. A method for determining inventory build and bleed times for consumer products as recited in claim 8, wherein said consumer products are intended for human and animal consumption.

10. A method for determining inventory build and bleed times for consumer products as recited in claim 8, wherein pre-selected group of supplemental factors includes pricing, advertising levels, merchandising, packaging size, seasonality, and combinations thereof.

11. A method for increasing forecasting accuracy for shipment and inventory control as recited in claim 8, wherein said at least one location includes retail and wholesale locations.

12. A method for increasing forecasting accuracy for shipment and inventory control as recited in claim 11, wherein said retail and wholesale locations are grocery outlets.

13. A method for increasing forecasting accuracy for shipment and inventory control as recited in claim 8, wherein said retail and wholesale locations include channel outlets.

14. A system for increasing forecasting accuracy for shipment and inventory levels, comprising;
a first data set, said first data set having a consumer demand profile,
a group of ancillary elements known to influence consumer demand;
said consumer demand profile obtained from historical purchasing levels that have been adjusted according to at least a portion of said group of ancillary elements;
a second data set, said second data set including historical shipment information that has been adjusted according to at least a portion of said group of ancillary elements;
a third data set, said third data set including historical inventory levels from at least one location;
at least one calculator that compares information contained in each of said first, second and third data sets to generate a correction factor to modify said consumer demand profile contained in said first data set; and
a display for illustrating future shipment and inventory requirements for said at least one location.

15. A system for increasing forecasting accuracy for shipment and inventory levels as recited in claim 14, wherein said system is used for consumer products.

16. A system for increasing forecasting accuracy for shipment and inventory levels as recited in claim 15, wherein the consumer products are products intended for human and animal consumption.

17. A system for increasing forecasting accuracy for shipment and inventory levels as recited in claim 14, wherein said group of ancillary elements includes pricing, advertising levels, merchandising, packaging size, seasonality, and combinations thereof.

18. A system for increasing forecasting accuracy for shipment and inventory levels as recited in claim 14, wherein said at least one location includes retail and wholesale locations.

19. A system for increasing forecasting accuracy for shipment and inventory levels as recited in claim 18, wherein said retail and wholesale locations are grocery outlets.

20. A system for increasing forecasting accuracy for shipment and inventory levels as recited in claim 18, wherein said retail and wholesale locations include channel outlets.

21. A shipping demand forecasting system, comprising;
a first data set including information on actual sales information, said first data set further including data from a group of supplemental and external factors that effect said sales information;
a second data set including information on inventory levels for at least one location;
a third data set including information on actual shipments made to said at least one location;
a comparator for comparing said first data set to said third data set to determine a correction factor to create a sales information forecast, said comparator then comparing said sales information forecast with said second data set from said at least one location; and
wherein said comparator creates a report setting forth an estimated shipping forecast for said at least one location from said first, second and third data sets, and said report provides information for planning for said group of supplemental and external factors.

22. A shipping demand forecasting system as recited in claim 21, wherein said group of supplemental and external factors includes pricing, advertising levels, merchandising, packaging size, seasonality, and combinations thereof.

23. A shipping demand forecasting system as recited in claim 21, wherein said is used for consumer products.

24. A shipping demand forecasting system as recited in claim 21, wherein said consumer products are intended for human and animal consumption.

25. A shipping demand forecasting system as recited in claim 21, wherein said at least one location includes retail and wholesale locations.

26. A shipping demand forecasting system as recited in claim 25, wherein said retail and wholesale locations are grocery outlets.

27. A shipping demand forecasting system as recited in claim 25, wherein said retail and wholesale locations include channel outlets.

28. A shipping demand forecasting system as recited in claim 25, wherein said channel outlets include drug stores, convenience stores, discounters and mass merchandisers.
